(19) United States
(12) Patent Application Publication
(10) Pub. No.: US 2025/0392580 A1
(43) Pub. Date: Dec. 25, 2025

(54) AUTHORISATION SYSTEM TO VALIDATE AN ACCESSOR AND A METHOD THEREOF

(71) Applicant: AMIT KUMAR GAUTAM, PUNE (IN)

(72) Inventor: AMIT KUMAR GAUTAM, PUNE (IN)

(73) Assignee: ABLUVA PRIVATE LIMITED, PUNE (IN)

(21) Appl. No.: 19/241,429

(22) Filed: Jun. 18, 2025

Related U.S. Application Data
(60) Provisional application No. 63/663,705, filed on Jun. 25, 2024.

(51) Int. Cl. H04L 9/40

(52) U.S. Cl. CPC H04L 63/08

(57) ABSTRACT

A system and method to validate an accessor accessing a datastore is disclosed. When a data access request formulated using a data access language is received, a first representation based on parameters of the data access language and characteristics of the accessor is generated. A second representation is generated based on data characteristics and execution characteristics of an execution plan. An information-interaction-signature is generated based on the first and second representations. The accessor is validated based on the generated signature and one or more validation strategies. The system and method utilize data access language patterns and execution plans to generate a signature, enhancing the capability to make informed authorization decisions and reinforce intrusion detection measures.

### FIELD OF THE INVENTION

The present disclosure relates to access control for datastores. More particularly, the present disclosure relates to a system and a method for validating an accessor that is accessing a datastore based on data access language patterns and query execution analysis.

### BACKGROUND

In recent times, protection of data and sensitive information is of utmost importance. Data and information may be generally stored in various datastores which may be accessed via data access languages (DALs). Data access languages are specialized languages for interaction with datastores. Users trying to access data (accessors) can use a set of commands or statements to interact with the datastore. The interactions may include querying, addition, deletion, and updating data within the datastore.

One example of data access language is SQL (Structured Query Language) that is widely used for accessing relational datastores. It allows users to define, manipulate, and control data stored in the datastores. In addition to SQL, there are other data access languages and frameworks designed to interact with datastores.

Authorization is the process of determining whether an accessor has the necessary permissions to access a datastore and perform specific actions. Access control policies can be enforced and access can be controlled. Authorization may rely on behaviour patterns for access control, i.e., typical ways in which accessors interact with the datastores. Representation of accessor's behavioural characteristics can be derived and used to identify and authorize the accessor. Though behavioural characteristics are considered, shallow interactions limited to access type, read, write, etc. are taken into account for access decisions.

One of the drawbacks of existing authorization techniques is that intricacies of patterns inherent in data access languages and the execution plans of access requests are not considered. For instance, prevailing behavior-centric approaches fall short in recognizing the dynamic, fluid, and individual-style influenced nature of the data access language employed by accessors. Accessors might engage with similar datasets or execute comparable operations, utilizing diverse language patterns that are not explicitly captured within behavior-based signatures.

Further, execution plans outline how a query will be processed at the datastore. Anomalies in these plans can serve as indicators of potentially malicious activities. Neglecting the analysis of execution plans may lead to overlooking specific types of attacks that manipulate queries or attempt to exploit vulnerabilities within the datastore.

Therefore, there is a pressing need for techniques that takes into account data language access patterns as well as query execution analysis. Therefore, in view of the above-mentioned problems, it is desirable to provide a system and a method for validating an accessor that is accessing a datastore based on data access language patterns and query execution analysis.

### SUMMARY

In an aspect, the present invention is directed to a computer-implemented method for validating an accessor accessing a datastore. The method comprises receiving a data access request from a device associated with the accessor, wherein the data access request is formulated using a data access language. The method comprises generating a first representation associated with the data access request based on one or more parameters of the data access language and one or more accessor characteristics. The method comprises generating a second representation associated with an execution plan for accessing the datastore based on one or more data characteristics associated with data to be accessed and one or more execution characteristics associated with the data access request. The method comprises generating an information-interaction-signature based on the first representation and the second representation, the signature defining a machine-readable structure representing characteristics of interactions of the accessor with the datastore. The method comprises validating the accessor to determine a validation outcome based on the generated information-interaction-signature and one or more validation strategies.

In an aspect, the present invention is directed to a system for validating an accessor accessing a datastore. The system comprises one or more processors and a memory storing instructions executed by the one or more processors. The instructions cause the one or more processors to be configured to receive a data access request from a device associated with the accessor, wherein the data access request is formulated using a data access language. The one or more processors are further configured to generate a first representation associated with the data access request based on one or more parameters of the data access language and one or more accessor characteristics. The one or more processors are further configured to generate a second representation associated with an execution plan for accessing the datastore based on one or more data characteristics associated with data to be accessed and one or more execution characteristics associated with the data access request. The one or more processors are further configured to generate an information-interaction-signature based on the first representation and the second representation, the signature defining a machine-readable structure representing characteristics of interactions of the accessor with the datastore. The one or more processors are further configured to validate the accessor to determine a validation outcome based on the generated information-interaction-signature and one or more validation strategies.

In an aspect, the present invention is directed to a non-transitory computer-readable storage medium comprising instructions executable by a processor. The instructions cause the processor to perform or control performance of operations. The operations comprise receiving a data access request from a device associated with the accessor, wherein the data access request is formulated using a data access language. The operations comprise generating a first representation associated with the data access request based on one or more parameters of the data access language and one or more accessor characteristics. The operations comprise generating a second representation associated with an execution plan for accessing the datastore based on one or more data characteristics associated with data to be accessed and one or more execution characteristics associated with the data access request. The operations comprise generating an information-interaction-signature based on the first representation and the second representation, the signature defining a machine-readable structure representing characteristics of interactions of the accessor with the datastore. The operations comprise validating the accessor to determine a validation outcome based on the generated information-interaction-signature and one or more validation strategies.

These and other objects, features, and advantages of the present disclosure will become more readily apparent from the attached drawings and the detailed description of the preferred embodiments, which follow.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an environment comprising a system for validating an accessor and generating information-interaction-signature to uniquely identify the accessor, in accordance with an embodiment of the present disclosure;

FIG. 2 illustrates a block diagram of the system for validating an accessor and generating information-interaction-signature to uniquely identify the accessor, in accordance with an embodiment of the present disclosure;

FIG. 3 illustrates a process flow depicting operations among a set of modules of the system, in accordance with an embodiment of the present disclosure;

FIG. 4 illustrates a process flow depicting a method associated with the system for validating an accessor and generating information-interaction-signature to uniquely identify the accessor, in accordance with an embodiment of the present disclosure; and

FIG. 5 illustrates a process flow depicting a method associated with validating an accessor accessing a datastore, in accordance with an embodiment of the present disclosure.

Further, skilled artisans will appreciate that elements in the drawings are illustrated for simplicity and may not have necessarily been drawn to scale.

Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION OF FIGURES

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure will be described below in detail with reference to the accompanying drawings.

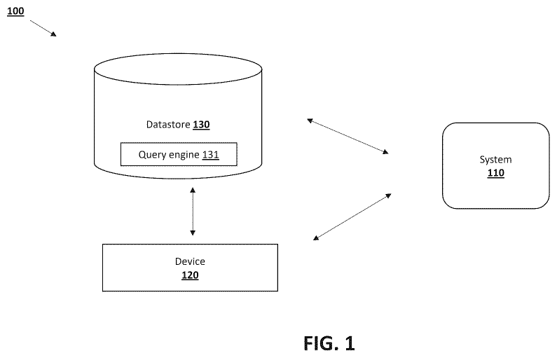

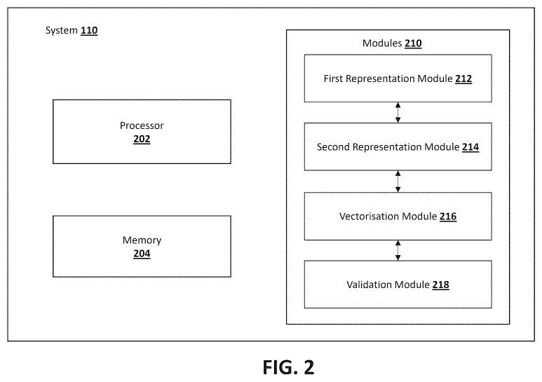

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

FIG. 1 illustrates a block diagram of an environment 100 comprising an authorization system 110 for validating an accessor and generating information-interaction-signature to uniquely identify the accessor, according to an embodiment of the present invention. The environment 100 comprises a device 120 associated with the accessor and in communication with the system 110. In an embodiment, the system 110 may be implemented in conjunction with the device 120. For instance, the system 110 may be integrated within the device 120. In another embodiment, the system 110 may be implemented in a cloud-based server remote from the device 120. In such a scenario, the system 110 may be in communication with the device 120 via a suitable communication network.

The device 120 may be in communication with a datastore 130 configured to store data and sensitive information. The device 120 may comprises a user interface allowing the accessor to access the datastore 130. The device 120, the system 110, and the datastore 130 may form part of an organization. It is to be noted herein that the term ‘datastore’ refers to an entity which may be interacted with using a defined data access language. The datastores may include databases, data lakes, and the like. The details described in the present disclosure are intended to include methods and systems for validating an accessor trying to access such a datastore, i.e., any entity which may be interacted with using a defined data access language. Hereinafter, the term ‘datastore’ is utilized to explain the invention and for sake of brevity, however, it is appreciated that the invention is not limited to any specific type of datastore. Rather, the invention encompasses any entity which can be accessed using a defined data access language. In non-limiting examples, such entities may include GraphQL, cloud-based databases, data-center based databases, data lakes, etc.

The device 120 may enable the accessor to send a query for accessing the datastore 130. The datastore 130 may be associated with a query engine 131 to receive and process the query.

In an exemplary embodiment, the device 120 may include a laptop computer, a desktop computer, a smartphone, and the like. Further, the network connecting the device 120 with the datastore 130 and the system 110 may include a wireless network or a wired network. For example, the network corresponds to Wi-Fi, cellular networks such as 3G, 4G, 5G, pre-5G, 6G network, or any other wireless communication network.

FIG. 2 illustrates a block diagram of the system 110 depicted in FIG. 1. The system 110 includes one or more processors 202 (alternatively referred to as a ‘processor 202’) and a memory 204. As a non-limiting example, the one or more processors 202 are a single processing unit or a set of units each including multiple computing units. The one or more processors 202 are implemented as one or more microprocessors, microcomputers, microcontrollers, digital signal processors, central processing units, state machines, logic circuitries, and/or any devices that manipulate signals based on operational instructions (computer-readable instructions) stored in the memory 204. Among other capabilities, the one or more processors 202 are configured to fetch and execute computer-readable instructions and data stored in the memory 204. The one or more processors 202 include one or a plurality of processors. The plurality of processors are further implemented as a general-purpose processor, such as a central processing unit (CPU), an application processor (AP), or the like, a graphics-only processing unit, such as a graphics processing unit (GPU), a visual processing unit (VPU), and/or an AI-dedicated processor such as a neural processing unit (NPU). The plurality of processors control the processing of the input data in accordance with a predefined operating rule or an artificial intelligence (AI) model stored in the memory 204. The predefined operating rule or the AI model is provided through training or learning.

The one or more processors 202 are disposed in communication with one or more input/output (I/O) devices via an Input/Output (I/O) interface. The I/O interface employs communication code-division multiple access (CDMA), high-speed packet access (HSPA+), global system for mobile communications (GSM), long-term evolution (LTE), WiMax, or the like, etc. In another embodiment of the present invention, the I/O interface employs ethernet, industrial wireless Local Area Network (LAN), Process Field Bus (PROFIBUS), Actuator Sensor (AS) Interface, and the like.

In some embodiments, the memory 204 is communicatively coupled to the one or more processors 202. The memory 204 is configured to store instructions executable by the one or more processors 202. In one embodiment, the memory 204 communicates via a bus within the system 110. The memory 204 includes, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory includes a cache or random-access memory (RAM) for the one or more processors 202.

In alternative examples, the memory 204 is separate from the one or more processors 202 such as a cache memory of a processor, the system memory, or other memory. The memory 204 is an external storage device or a datastore for storing data. The memory 204 is operable to store instructions executable by the one or more processors 202. The functions, acts or tasks illustrated in the figures or described are performed by the programmed processor for executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies include multiprocessing, multitasking, parallel processing, and the like.

The memory 204 may include an operating system for performing one or more tasks of the system 110, as performed by a generic operating system in the communications domain. In one embodiment, the memory 204 is configured to store the information as required by the one or more processors 202 to perform one or more functions for validating accessors based on data access language patterns and query execution analysis.

The system 110 further comprises a set of modules 210. The processor 202 may be configured to perform designated functions in conjunction with the memory 204 and the set of modules 210. In some embodiments, the set of modules 210 may be included within the memory 204. In some embodiments, the set of modules 210 may include a set of instructions that may be executed to cause the system 110, in particular, the processor 202, to perform any one or more of the methods disclosed herein. The set of modules 210 in conjunction with the processor 202 may be configured to perform the steps of the present disclosure using the data stored in the memory 204, as discussed throughout this disclosure. In an embodiment, each of the set of modules 210 may be software modules within the memory 204. In an embodiment, each of the set of modules 210 may be hardware units that may be outside the memory 204.

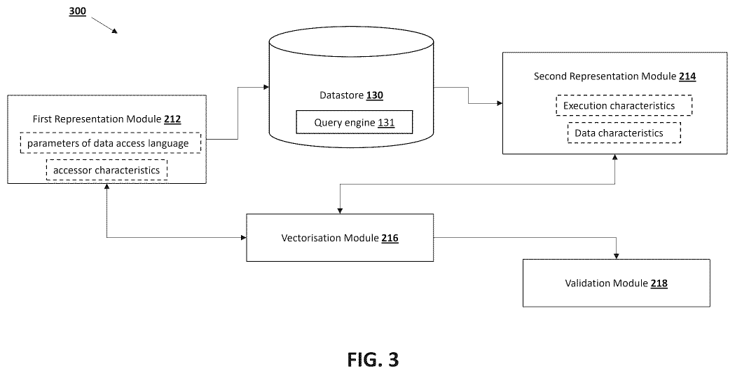

FIG. 3 illustrates a process flow 300 depicting operations among the set of modules 210 of the system 110. Details of the invention will now be described collectively with FIGS. 1-3.

The term ‘accessor’ may be interchangeably referred to as ‘user’ hereinafter.

The processor 202 in conjunction with the set of modules 210 may be configured to create a signature for making authorization decisions and bolstering intrusion detection. The created signature allows validating the accessor and identifying any intrusions or unauthorized access.

Initially, the processor 202 may receive a data access request (alternatively referred to as ‘query’) from the accessor via the device 120. The data access request may be formulated using a data access language.

The processor 202 in conjunction with a first representation module 212 may be configured to generate a first representation associated with the data access request formulated using the data access language that is being utilized for accessing the datastore 130. The first representation may be generated based on one or more parameters associated with the data access language and one or more accessor characteristics.

The data access language may include, in non-limiting examples, SQL, Application Programming Interface (API) calls, etc. The one or more parameters associated with the data access language facilitate understanding of the accessor's actions. The one or more parameters associated with the data access language may be obtained by the processor 202 in conjunction with a first representation module 212 based on a query or a series of queries provided by the accessor to access the datastore 130. In an embodiment, syntactic and semantic information related to the query or series of queries may be considered by the processor 202 to obtain the one or more parameters associated with the data access language. In an embodiment, the syntactic and semantic information may be obtained based on intercepted interactions between the datastore 130 and the device 120 via which the accessor sends the query or series of queries, accessing system logs, contextual relationships from individual interactions, and/or contextual relationships from correlated series of interactions over a time horizon.

The one or more parameters associated with the data access language include structure of queries in the data access language being used to access the datastore, such as, query syntax, query structure, an embedded token, abstract syntax tree, query style, comments, headers, hints, etc.

The one or more parameters associated with the data access language may further include, in non-limiting examples:
User-Defined Function (UDF)—UDF allows accessors to define custom functions in SQL or other query languages. These functions can be used within queries to perform specific operations on the data.
Join patterns—Join patterns describe how datasets are joined together in a query.
Abstract Syntax Tree (AST)—AST represents the hierarchical structure of code in an abstract form, commonly used in compilers and interpreters to analyze and process code.
Hints—Hints provide suggestions to the query engine for query execution.
Comments—Comments are annotations within SQL code for documentation purposes.
Keywords—Keywords are reserved words in SQL that have specific meanings (e.g., SELECT, FROM, WHERE).
Sub-query Patterns—Patterns involving nested queries within a larger query.
Message Structure and Schema for gRPC Remote Procedure Calls.
Fields and Arguments of Graph Query Language (GraphQL)

As described above, the first representation may be generated based on accessor characteristics for each interaction with the datastore 130. The accessor characteristics may include, as non-limiting examples, information of the accessor, role of the accessor, purpose for accessing the datastore 130, time of the data access request, and location of the accessor, etc.

The one or more accessor characteristics may be obtained by the processor 202 in conjunction with a first representation module 212 based on accessor information derived during one or more of authentication of the accessor, authorisation of the accessor, interactions between the accessor (e.g., via the device 120) and the datastore 130, and/or interactions between the accessor (e.g., via the device 120) and the datastore 130. In an embodiment, the one or more accessor characteristics may be obtained based on correlations between multiple events associated with the access to the datastore 130. One example of the events may include average volume or records fetched over multiple sessions from the datastore 130.

In an embodiment, the one or more parameters associated with the data access language may be obtained over multiple time windows. The multiple time windows may correspond to pre-defined time durations.

In an embodiment, the data access language may be augmented with a service-linked or user-identity-linked token as a parameter so as to strengthen authentication and traceability. The token may be embedded within query text, metadata fields, or transmitted alongside the access queries. The token may carry verifiable metadata such as user identity, device ID, session ID, etc. In an embodiment, the token may be structured to contribute to both the one or more accessor characteristics and the one or more parameters associated with the data access language.

The processor 202 in conjunction with a second representation module 214 may be configured to generate a second representation associated with an execution plan for accessing the datastore 130. The second representation may be generated based on one or more data characteristics associated with data to be accessed and one or more execution characteristics associated with the data access request.

The execution plan may be associated with the query engine 131 of the datastore 130. The query engine 131 may be responsible for interpreting, optimizing, and executing queries received from the accessor (e.g., via the device 120). Upon receiving the data access request, i.e., a query, the query engine 131 may perform multiple stages of processing, including parsing the query, analyzing the required operations, and generating one or more execution plans, and retrieving the data from the datastore 130 based on the one or more execution plans. The execution plan may be indicative of a structured representation of the operations and data access strategies that the query engine 131 has determined necessary to fulfil a received query. For a given query the second representation generated by the processor 202 may be associated with the execution plan for accessing the datastore 130 and may be determined based on the one or more data characteristics and one or more execution characteristics.

In an embodiment, the operations and data access strategies represented by the execution plan may be indicative of one or more of execution order, access paths, join methods, cost estimate, row or output estimates, parallelism, filter/predicate info, temporary structures, index usage, workflow steps or task Directed Acyclic Graphs (DAGs), tool chaining, optimisations, reasoning steps, dependencies, input/output mapping, and/or fallbacks or monitors.

In an embodiment, the one or more data characteristics may include one or more of sensitivity of the data to be accessed within the datastore 130, usage of the data, and purpose of the data. In an embodiment, the processor 202 may in conjunction with the second representation module 214 may obtain the one or more data characteristics from external catalogues and/or metadata dictionaries. In an embodiment, procedures/code or lookups may be utilized to determine the one or more data characteristics. In an embodiment, the processor 202 may in conjunction with the second representation module 214 may obtain the one or more data characteristics from the query engine 131 associated with the datastore 130.

In an embodiment, the one or more execution characteristics may include physical plan, logical plan, execution mode, cost, row counts, indexes, access paths, temporal information, etc. The temporal information may include time of execution and length of execution. In an embodiment, the processor 202 may in conjunction with the second representation module 214 may obtain the one or more execution characteristics from the query engine 131 associated with the datastore 130.

The term ‘representation’ as used herein may refer to structured abstraction of data or information that enables validation and detection of unauthorised access. The first representation may refer to a structured abstraction of information that characterizes the nature of a query and nature of the accessor. The second representation may refer to a structured abstraction of information that characterizes execution strategies for queries and nature of data to be accessed by the queries. In some embodiment, the first representation and the second representation may be expressed in machine-usable form such as but not limited to syntax trees, graphs, dictionaries, feature maps, vectors, etc.

The processor 202 in conjunction with a vectorisation module 216 may be configured to generate an information-interaction-signature based on the first representation and the second representation generated by the first representation module 212 and the second representation module 214, respectively.

In an embodiment, the information-interaction-signature may refer to accessor specific representations. It may be noted that accessor may include individual accessor or accessor groups. The information-interaction-signature may be a multidimensional representation of characteristics associated with interactions of the accessor with the datastore 130 and/or with the system 110. In an embodiment, the information-interaction-signature may be a representation of such interaction characteristics organized into quantifiable and categorical features across temporal, operational, contextual, and semantic dimensions. In an embodiment, the information-interaction-signature may be stored as a fixed-dimensional vector, graph, or feature map, or any other machine-readable representation so as to be suitable for statistical modeling, anomaly detection, and similarity comparison.

In an embodiment, the information-interaction-signature may be generated based on auto-encoder or similar models. In an embodiment, the information-interaction-signature may be generated based on one or more statistical models including but not limited to Gaussian Mixture Models (GMM), Hidden Markov Models (HMM), Kernel Density Estimation (KDE), Principal Component Analysis (PCA), t-distributed Stochastic Neighbor Embedding (t-SNE)/Uniform Manifold Approximation and Projection (UMAP) (for visualization or clustering), and Time-series statistical profiling (e.g., moving average, entropy). In an embodiment, the information-interaction-signature may be generated based on one or more machine learning models including but not limited to, k-Means/Density-Based Spatial Clustering of Applications with Noise (DBSCAN)/Hierarchical Density-Based Spatial Clustering of Applications with Noise (HDBSCAN) (Clustering-based signatures), Random Forests (feature importance for behavior vectors), One-Class Support Vector Machines (SVM), Isolation Forest, Autoencoders (deep or shallow), Variational Autoencoders (VAE), LSTM-based sequence models, Transformer-based encoders, Siamese Networks (for user similarity), and Graph Neural Networks (GNNs for user-action graphs). In an embodiment, the information-interaction-signature may be generated based on one or more Artificial Intelligence (AI) models including but not limited to generative AI or foundation models, Bidirectional Encoder Representations from Transformers (BERT) style models fine-tuned on interaction logs, Generative Pre-trained Transformer (GPT) style models (e.g., for behavior sequence generation or next-action prediction), Graph2Vec/Node2Vec/DeepWalk (for embedding user activity graphs), Diffusion models for behavior pattern generation, RAG (Retrieval-Augmented Generation) for semantic signature enrichment, and Contrastive Learning (SimCLR, SupCon) for embedding behavior differences.

In some embodiments, the information-interaction-signature may be generated across multiple time-bound data access windows. This enables modeling of cumulative behavioral patterns associated with the accessor over time, thereby identifying evolving behaviors, repeated patterns, or gradual deviations. In some embodiments, the information-interaction-signature may be generated by taking into account intent estimation for each data access interaction. Such intent may be inferred implicitly based on one or more previously described parameters (e.g., query structure, keywords, metadata), or may be extracted explicitly from embedded annotations such as query comments or access labels, thereby enhancing semantic understanding of the accessor's behavior. In some embodiments, the information-interaction-signature may be generated by taking into account resource sensitivity information, i.e., the criticality or confidentiality of the data being accessed. This allows for mitigation of insider threats that may target highly sensitive data resources.

In some embodiments, the information-interaction-signature may be generated by taking into consideration one or more behavior modeling or data abstraction characteristics to server as inputs to the statistical, machine learning, or artificial intelligence models described above. The one or more behavior modeling or data abstraction characteristics may include one or more of:
Derived Risk History Vector: Rolling statistics of historical risk scores or anomaly alerts associated with the accessor's past activity.
Instruction Drift Detection: Deviation analysis in the nature of accessor instructions, including changes in query structures, prompts, or output intent over time.
Action Proximity Graph: A temporally or logically linked directed graph representing recent actions of the accessor.
Interleaved Session Detection: Identification of overlapping or concurrent access sessions from the same accessor across multiple environments or contexts.
Intent Estimation Using LLMs: Use of language models (LLMs) to infer the intent behind an accessor's actions from logs, query text, or command traces.
Role and Peer Deviation Embedding: Comparative modeling of the accessor's behavior relative to peer groups or organizational roles to identify outlier or anomalous actions.
Access Volume and Entropy Metrics: Quantitative tracking of volume (e.g., number of rows or files accessed) and entropy (e.g., diversity of resources or fields) to detect irregular access patterns.
Device and Identity Surface Mapping: Profiling of accessor identity in conjunction with device-level metadata such as fingerprinting, IP address, geolocation, and authentication methods.
Access Event Contiguity Across Time Windows: Modeling of sequences of access events that span multiple logical sessions or time windows, useful for detecting stealthy or persistent behavior.

Further, the processor 202 in conjunction with the validation module 218 may be configured to validate the accessor to determine a validation outcome based on the generated information-interaction-signature. In an embodiment, the validation module 218 may classify or label the accessor as one of authorized accessor or unauthorized accessor thereby determining the validation outcome. In an embodiment, the validation outcome may be positive when the accessor is classified as an authorized accessor and the validation outcome may be negative when the accessor is classified as an unauthorized accessor. In an embodiment, the unauthorized accessor may be deemed to be bots or intruders. The validation module 218 may thus facilitate in intruder detection, behaviour modelling, and user-similarity detection.

In some embodiments, the processor 202 in conjunction with the validation module 218 may validate the accessor using the information-interaction-signature through one or more validation strategies. The one or more validation strategies may be selected based on pre-defined system policy, sensitivity of access, or historical behavior trends. The one or more validation strategies may be used stand-alone or in any combination with each other.

The one or more validation strategies may include automated point-in-time validation based on contextual matching, wherein the processor 202 may match a current access context including, but not limited to, the accessor identity, access method, system environment parameters, and data resource properties, against the information-interaction-signature to determine the validation outcome.

The one or more validation strategies may include interactive point-in-time validation involving signature-linked prompts, wherein challenge prompts based on elements from the accessor's historical signatures (such as prior access queries, prompts, or outcomes) may be generated and presented to the accessor by the processor 202. The response from the accessor may be validated by the processor 202 to determine the validation outcome. For example, the system may query the accessor with a question derived from their historical interaction signature, such as “Name the last project you accessed.”

The one or more validation strategies may include automated observation over a timespan, wherein the system 110 may monitor and accumulate interactions of the accessor with the datastore 130 over a predefined or dynamic time window. The monitored interactions may be compared to the information-interaction-signature or to multiple information-interaction-signatures generated over the time window to determine the validation outcome.

The one or more validation strategies may include automated observation and interaction over a timespan, wherein interactive point-in-time validation and automated observation over a timespan described above may be used together to determine the validation outcome.

Accordingly, the information-interaction-signature may serve as the reference model against which both real-time and time-windowed interactions of the accessor may be validated by the processor 202 in conjunction with the validation module 218 to determine the validation outcome.

In an embodiment, when the processor 202 in conjunction with the validation module 218 classifies the accessor as an authorized accessor, the processor 202 may label the accessor as authorised for an ongoing session and may adjust (decrease) a risk score associated with the accessor. Over time, the risk score may be decreased in cases of successful authorisations and may be increased in cases of unsuccessful authorisations. In an embodiment, when the processor 202 in conjunction with the validation module 218 classifies the accessor as an authorized accessor, the processor 202 may auto-grant additional access to the accessor based on the past interactions and authorisations.

In an embodiment, when the processor 202 in conjunction with the validation module 218 classifies the accessor as an unauthorized accessor, the processor 202 may label the accessor as unauthorised for an ongoing session and may increase the risk score associated with the accessor. In other embodiments, the processor 202 may auto disconnect the ongoing session of the accessor, transmit notifications indicative of failed authorisation to external systems, restrict accessor access area for future interactions, and/or serve pseudo data to the accessor to allow the accessor to stay engaged while security teams can identify and take action against the accessor.

In some embodiments, for long-term context aware authorization, an authorisation graph may be generated by the processor 202. The authorisation graph may be generated for a series of queries of the accessor or interactions of the accessor with the datastore over a pre-defined time window or time horizon. In an embodiment, the processor 202 may generate respective information-interaction-signatures for each of the plurality of additional data access requests and generate the authorisation graph based on the respective information-interaction-signatures.

In an embodiment, the authorisation graph may be generated based further on contextual information associated with the series of queries sent by the accessor (query execution, retry attempts, query edits, timing gaps, AST changes, etc.), and additionally or optionally, based on the accessor characteristics, the data access language parameters, and the information-interaction-signatures that have been generated for the series of queries. The validation outcome may be determined by the processor based on the authorisation graph. The authorisation graph may thus capture evolving behaviour of the accessor over the time horizon. The authorisation graph may be stored in the memory 204. In some embodiments, the validation module 218 may consider the authorisation graph for validating the accessor in future access attempts.

In an embodiment, based on the validation outcome, the processor 202 may be configured to generate an alert indicative of the validation outcome and transmit the alert to one or more other devices or systems. The external devices or systems may include devices operated by administrators of the datastore, monitoring systems, security management systems, or other systems configured to take action in response to access validation results (e.g., in response to unauthorized access). The alerts may be used to initiate administrative review, adjust access rights, and/or trigger security protocols.

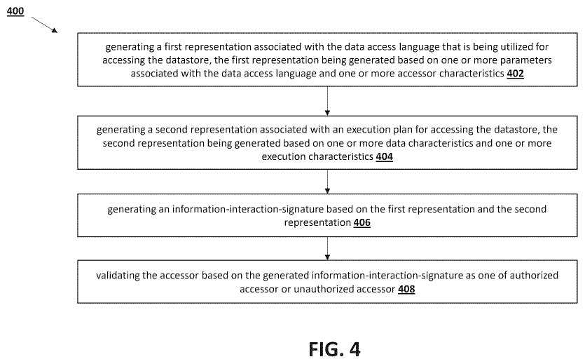

FIG. 4 illustrates a process flow depicting a method 400 associated with the system 110 for creating a signature for making authorization decisions and bolstering intrusion detection and validating the accessor to prevent unauthorized access. The method 400 may be performed by the system 110, in particular, with the processor 202 in conjunction with the modules 210.

At step 402, the method includes generating a first representation associated with the data access language that is being utilized for accessing the datastore 130. The first representation may be generated based on one or more parameters associated with the data access language and one or more accessor characteristics.

At step 404, the method includes generating a second representation associated with an execution plan for accessing the datastore 130. The second representation may be generated based on one or more data characteristics and one or more execution characteristics.

At step 406, the method includes generating an information-interaction-signature based on the first representation and the second representation.

At step 408, the method includes validating the accessor based on the generated information-interaction-signature as one of authorized accessor or unauthorized accessor.

It is to be noted that the details involved in the steps of the method 400 have been detailed with reference to FIGS. 1-3 and have not been repeated herein for the sake of brevity.

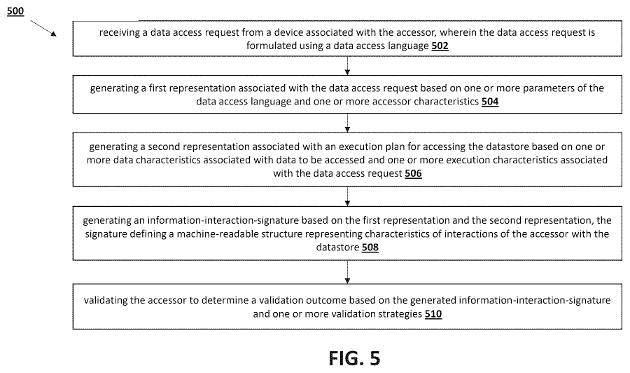

FIG. 5 illustrates a process flow depicting a method 500 associated with the system 110 for validating an accessor accessing the datastore 130. The method 500 may be performed by the system 110, in particular, with the processor 202 in conjunction with the modules 210.

At step 502, the method can include receiving a data access request from the device 120 associated with the accessor. The data access request can be formulated using a data access language.

At step 504, the method can include generating a first representation associated with the data access request based on one or more parameters of the data access language and one or more accessor characteristics.

In an embodiment, the first representation may define a structured abstraction in the form of a syntax tree, vector, graph, dictionary, or feature map.

In an embodiment, the one or more parameters of the data access language may be indicative of syntactic and semantic information related to the data access request.

In an embodiment, the one or more parameters of the data access language may include one or more of: query syntax, query structure, query style, an embedded token, Abstract Syntax Tree (AST), User-Defined Function (UDF), join patterns, comments, keywords, sub-query patterns, headers, and hints.

In an embodiment, the one or more accessor characteristics may include one or more of information of the accessor, role of the accessor, purpose for accessing the datastore, location of the accessor, and time of the data access request.

At step 506, the method can include generating a second representation associated with an execution plan for accessing the datastore based on one or more data characteristics associated with data to be accessed and one or more execution characteristics associated with the data access request.

In an embodiment, the second representation may define a structured abstraction in the form of a syntax tree, vector, graph, dictionary, or feature map.

In an embodiment, the execution plan may be indicative of operations and data access strategies determined by the query engine 131 associated with the datastore based on the data access request.

In an embodiment, the generating the second representation may comprise obtaining the execution plan from the query engine.

In an embodiment, the one or more data characteristics may be indicative of sensitivity of data, usage of data, and purpose of data.

In an embodiment, the one or more execution characteristics may be indicative of one or more of physical plan, logical plan, execution mode, cost, row counts, indexes, access paths, and temporal information.

At step 508, the method can include generating an information-interaction-signature based on the first representation and the second representation, the signature defining a machine-readable structure representing characteristics of interactions of the accessor with the datastore.

In an embodiment, the information-interaction-signature may be generated using one or more of statistical models, machine learning models, and Artificial Intelligence (AI) models.

At step 508, the method can include validating the accessor to determine a validation outcome based on the generated information-interaction-signature and one or more validation strategies.

In an embodiment, the method 500 may further comprise transmitting alerts to external devices or systems based on the validation outcome.

In an embodiment, validating the accessor to determine the validation outcome may comprise classifying the accessor as one of an authorized accessor or an unauthorized accessor.

In an embodiment, the method 500 may further comprise updating a risk score associated with the accessor based on the validation outcome.

In an embodiment, updating the risk score may comprise increasing the risk score when the accessor is classified as an unauthorized accessor and decreasing the risk score when the accessor is classified as an authorized accessor.

In an embodiment, when the accessor is classified as an authorized accessor, the method may comprise serving pseudo data to the accessor or disconnecting an ongoing session for the accessor.

In an embodiment, the one or more validation strategies may comprise one or more of: automated point-in-time validation based on contextual matching, interactive point-in-time validation involving signature-linked prompts, and automated observation over a timespan.

In an embodiment, the method 500 may comprise receiving a plurality of additional data access requests from the accessor during a predefined time window. The method 500 may further comprise generating a respective information-interaction-signature for each of the plurality of additional data access requests. The method 500 may further comprise generating an authorisation graph based on contextual information associated with the plurality of additional data access requests and the respective information-interaction-signatures. The method 500 may further comprise determining the validation outcome for the accessor based on the authorisation graph, thereby capturing evolving behaviour of the accessor over the time window.

It is to be noted that the details involved in the steps of the method 500 have been detailed with reference to FIGS. 1-3 and have not been repeated herein for the sake of brevity.

Accordingly, the present invention provides a system and method to efficiently make authentication and authorisation decisions and detect intrusions by taking into account multiple factors including data access language patterns, query execution analysis, and contextual information of the present disclosure thus provides systems and methods for generating information-interaction-signature which enables uniquely identifying the accessor and preventing access to intrusion, bots and similar unauthorized accessors. Recognizing data access language patterns is essential in uncovering potential security threats, which could otherwise remain undetected by traditional authorization systems that rely on static role-based access control (RBAC) or signature-based rule enforcement. The disclosed systems and methods enable interpretation of what the accessor is trying to do (via query semantics), how the query engine is likely to respond (via execution plan), and why the accessor may be doing it (via contextual signals and business metadata). Gaining insights into how users formulate queries enables the system to establish query-style-based signatures, enhancing its ability to identify abnormal or potentially malicious patterns.

Analyzing the execution plans of data access operations enables the system to understand the methodology of the datastore query engine for each query. Anomalies in execution plans may signal malicious intent or unintended behavior. By incorporating execution plans into the evaluation, a more nuanced control over access decisions is attained, factoring in the intricacies of how a query is slated for execution. In other words, reviewing the query parsing process can unveil potential threats in the pretext of malformed or suspicious queries. Departures from typical optimization patterns could signal malicious intent. Scrutinizing the selected access paths and index usage yields insights into the anticipated data retrieval mechanism. Irregularities in this domain may indicate unauthorized attempts to access sensitive information.

By evaluating access intent, potential data impact, and contextual justification in real time, the system grants or denies scopes dynamically, thus ensuring a least-privilege, context-aware security posture. This effectively addresses the limitations of existing models that fail to account for adaptive, multi-dimensional, and semantic behavior-based risks. Furthermore, the disclosed systems and methods extend beyond traditional User and Entity Behavior Analytics (UEBA) systems by actively intervening in authorization decisions rather than just passively detecting anomalies. This represents a significant improvement in preventing data breaches, privilege escalation, and insider misuse while minimizing operational friction in legitimate use cases.

This invention thus introduces systems and methods that utilizes data access language patterns and execution plans to generate a signature for validating accessors, enhancing the capability to make informed authorization decisions and reinforce intrusion detection measures.

In an embodiment, the system 110 is provided in a distributed manner, in that, one or more components and/or functionalities of the system 110 are provided through an electronic device, and one or more components and/or functionalities of the system 110 are be provided through a cloud-based unit, such as, a cloud storage or a cloud-based server. In a non-limiting example, the memory 204 may be provided through the cloud storage and the one or more processors 202 may be integrated with an electronic device (such as the device 120).

Further, the present invention also contemplates a computer-program product that includes instructions or receives and executes instructions responsive to a propagated signal. Further, the instructions may be transmitted or received over the network via a communication port or interface or using a bus (not shown). The communication port or interface may be a part of the one or more processors 202 or may be a separate component. The communication port may be created in software or may be a physical connection in hardware. The communication port may be configured to connect with the network, external media, the display, or any other components in the system 110. The connection with the network may be a physical connection, such as a wired ethernet connection, or may be established wirelessly. Likewise, the additional connections with other components of the system 110 may be physical or may be established wirelessly. The network may alternatively be directly connected to the bus. For the sake of brevity, the architecture, and standard operations of the memory 204 and the one or more processors 202 are not discussed in detail.

In an embodiment, the computer-program product, having machine-readable instructions stored therein, when executed by one or more processors 202, cause the one or more processors 202 to perform a method as elaborated in subsequent paragraphs at least with reference to FIG. 4.

Further, the present invention also contemplates a non-transitory computer-readable medium encoded with executable instructions. The executable instructions, when executed by one or more processors 202, cause the one or more processors 202 to perform a method as elaborated in subsequent paragraphs at least with reference to FIG. 4. Examples of computer-readable mediums include non-volatile, hard-coded type mediums such as read-only memories (ROMs) or erasable, electrically programmable read-only memories (EEPROMs), and user-recordable type mediums such as floppy disks, hard disk drives and compact disk read-only memories (CD-ROMs) or digital versatile disks (DVDs).

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

It will be appreciated that the modules, processes, systems, and devices described above can be implemented in hardware, hardware programmed by software, software instruction stored on a non-transitory computer readable medium or a combination of the above. Embodiments of the methods, processes, modules, devices, and systems (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the methods, systems, or computer program products (software program stored on a non-transitory computer readable medium).

Furthermore, embodiments of the disclosed methods, processes, modules, devices, systems, and computer program product may be readily implemented, fully or partially, in software using, for example, object or object-oriented software development environments that provide portable source code that can be used on a variety of computer platforms. Alternatively, embodiments of the disclosed methods, processes, modules, devices, systems, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the invention to produce additional embodiments. Furthermore, certain features may sometimes be used to advantage without a corresponding use of other features.

1. A computer-implemented method for validating an accessor accessing a datastore, the method comprising:
receiving a data access request from a device associated with the accessor, wherein the data access request is formulated using a data access language;
generating a first representation associated with the data access request based on one or more parameters of the data access language and one or more accessor characteristics;
generating a second representation associated with an execution plan for accessing the datastore based on one or more data characteristics associated with data to be accessed and one or more execution characteristics associated with the data access request;
generating an information-interaction-signature based on the first representation and the second representation, the signature defining a machine-readable structure representing characteristics of interactions of the accessor with the datastore; and
validating the accessor to determine a validation outcome based on the generated information-interaction-signature and one or more validation strategies.

2. The method according to claim 1, wherein validating the accessor to determine the validation outcome comprises:
classifying the accessor as one of an authorized accessor or an unauthorized accessor.

3. The method according to claim 2, comprising:
updating a risk score associated with the accessor based on the validation outcome,
wherein updating the risk score comprises increasing the risk score when the accessor is classified as an unauthorized accessor and decreasing the risk score when the accessor is classified as an authorized accessor.

4. The method according to claim 2, wherein when the accessor is classified as an authorized accessor, the method comprises:
serving pseudo data to the accessor; or
disconnecting an ongoing session for the accessor.

5. The method according to claim 1, wherein:
the one or more validation strategies comprise one or more of: automated point-in-time validation based on contextual matching, interactive point-in-time validation involving signature-linked prompts, and automated observation over a timespan.

6. The method according to claim 1, wherein the one or more parameters of the data access language is indicative of syntactic and semantic information related to the data access request, and wherein the one or more parameters of the data access language include one or more of: query syntax, query structure, query style, an embedded token, Abstract Syntax Tree (AST), User-Defined Function (UDF), join patterns, comments, keywords, sub-query patterns, headers, and hints.

7. The method according to claim 1, wherein the one or more accessor characteristics include one or more of information of the accessor, role of the accessor, purpose for accessing the datastore, location of the accessor, and time of the data access request.

8. The method according to claim 1, wherein the execution plan is indicative of operations and data access strategies determined by a query engine associated with the datastore based on the data access request, and
wherein generating the second representation comprises obtaining the execution plan from the query engine.

9. The method according to claim 1, wherein the one or more data characteristics are indicative of sensitivity of data, usage of data, and purpose of data, and wherein the one or more execution characteristics are indicative of one or more of physical plan, logical plan, execution mode, cost, row counts, indexes, access paths, and temporal information.

10. The method according to claim 1, wherein the first representation and the second representation each define a structured abstraction in the form of a syntax tree, vector, graph, dictionary, or feature map.

11. The method according to claim 1, wherein the information-interaction-signature is generated using one or more of statistical models, machine learning models, and Artificial Intelligence (AI) models.

12. The method according to claim 1, comprising:
receiving a plurality of additional data access requests from the accessor during a predefined time window;
generating a respective information-interaction-signature for each of the plurality of additional data access requests;
generating an authorisation graph based on contextual information associated with the plurality of additional data access requests and the respective information-interaction-signatures; and
determining the validation outcome for the accessor based on the authorisation graph, thereby capturing evolving behaviour of the accessor over the time window.

13. A system for validating an accessor accessing a datastore, the system comprising:
one or more processors; and
a memory storing instructions that, when executed by the one or more processors, cause the one or more processors to:
receive a data access request from a device associated with the accessor, wherein the data access request is formulated using a data access language;
generate a first representation associated with the data access request based on one or more parameters of the data access language and one or more accessor characteristics;
generate a second representation associated with an execution plan for accessing the datastore based on one or more data characteristics associated with data to be accessed and one or more execution characteristics associated with the data access request;
generate an information-interaction-signature based on the first representation and the second representation, the signature defining a machine-readable structure representing characteristics of interactions of the accessor with the datastore; and
validate the accessor to determine a validation outcome based on the generated information-interaction-signature and one or more validation strategies.

14. The system according to claim 13, wherein to validate the accessor to determine the validation outcome, the one or more processors are configured to:
classify the accessor as one of an authorized accessor or an unauthorized accessor;

15. The system according to claim 14, wherein the one or more processors are configured to:
update a risk score associated with the accessor based on the validation outcome,
wherein to update the risk score, the one or more processors are configured to increase the risk score when the accessor is classified as an unauthorized accessor and decrease the risk score when the accessor is classified as an authorized accessor.

16. The system according to claim 13, wherein:
the one or more parameters of the data access language is indicative of syntactic and semantic information related to the data access request, and wherein the one or more parameters of the data access language include one or more of: query syntax, query structure, query style, an embedded token, Abstract Syntax Tree (AST), User-Defined Function (UDF), join patterns, comments, keywords, sub-query patterns, headers, and hints,
the one or more accessor characteristics include one or more of information of the accessor, role of the accessor, purpose for accessing the datastore, location of the accessor, and time of the data access request,
the one or more data characteristics are indicative of sensitivity of data, usage of data, and purpose of data, and
the one or more execution characteristics are indicative of one or more of physical plan, logical plan, execution mode, cost, row counts, indexes, access paths, and temporal information.

17. The system according to claim 1, wherein the execution plan is indicative of operations and data access strategies determined by a query engine associated with the datastore based on the data access request, and
wherein to generate the second representation, the one or more processors are configured to obtain the execution plan from the query engine.

18. The system according to claim 1, wherein the first representation and the second representation each define a structured abstraction in the form of a syntax tree, vector, graph, dictionary, or feature map.

19. The system according to claim 1, wherein the one or more processors are configured to:
receive a plurality of additional data access requests from the accessor during a predefined time window;
generate a respective information-interaction-signature for each of the plurality of additional data access requests;
generate an authorisation graph based on contextual information associated with the plurality of additional data access requests and the respective information-interaction-signatures; and
determine the validation outcome for the accessor based on the authorisation graph, thereby capturing evolving behaviour of the accessor over the time window.

20. A non-transitory computer-readable storage medium comprising instructions executable by a processor, the instructions to cause the processor to perform or control performance of operations that comprise:
receiving a data access request from a device associated with the accessor, wherein the data access request is formulated using a data access language;
generating a first representation associated with the data access request based on one or more parameters of the data access language and one or more accessor characteristics;
generating a second representation associated with an execution plan for accessing the datastore based on one or more data characteristics associated with data to be accessed and one or more execution characteristics associated with the data access request;
generating an information-interaction-signature based on the first representation and the second representation, the signature defining a machine-readable structure representing characteristics of interactions of the accessor with the datastore; and
validating the accessor to determine a validation outcome based on the generated information-interaction-signature and one or more validation strategies.
